(19) United States
(12) Patent Application Publication
(10) Pub. No.: US 2011/0074555 A1
(43) Pub. Date: Mar. 31, 2011

(54) MOBILE RFID DEVICE AND DATA COMMUNICATION METHOD THEREOF

(75) Inventors: Chan-Won Park, Daejeon (KR); Man Sik Park, Daejeon (KR); Ji-Hoon Bae, Daejeon (KR); Donghan Lee, Daejeon (KR); Kwang-Soo Cho, Daejeon (KR); Won Kyu Choi, Daejeon (KR); Cheng-Hao Quan, Daejeon (KR); Jeong seok Kim, Daejeon (KR); Gil Young Choi, Daejeon (KR); Jong-Suk Chae, Daejeon (KR)

(73) Assignee: ELECTRONICS AND TELECOMMUNICATIONS RESEARCH INSTITUTE, Daejeon (KR)

(21) Appl. No.: 12/859,799

(22) Filed: Aug. 20, 2010

(30) Foreign Application Priority Data
Sep. 29, 2009 (KR) 10-2009-0092380
Apr. 26, 2010 (KR) 10-2010-0038594

(51) Int. Cl. H04Q 5/22

(52) U.S. Cl. 340/10.4

(57) ABSTRACT

Provided are a mobile Radio Frequency Identification (RFID) device and a data communication method thereof. In the method, a mobile communication terminal unit provides a command to an mRFID reader unit and receives a response to the command from the mRFID reader unit. It is checked whether there is an error in a protocol message of the command or the response, and the command to the mRFID reader unit according to a check result is re-transmitted.

### CROSS-REFERENCE TO RELATED APPLICATIONS

This U.S. non-provisional patent application claims priority under 35 U.S.C. §119 of Korean Patent Application Nos. 10-2010-0038594, filed on Apr. 26, 2010, and 10-2009-0092380, filed on Sep. 29, 2009, the entire contents of which are hereby incorporated by reference.

### BACKGROUND OF THE INVENTION

The present invention disclosed herein relates to a mobile electronic device, and more particularly, to a mobile Radio Frequency Identification (RFID) device and a data communication method thereof.

Radio Frequency Identification (RFID) technologies refer to technologies that read and write information from tags having unique identification information, in a contactless manner using radio frequency. The RFID technologies may recognize, track, and manage objects, animals and persons to which tags are attached. Such RFID technologies concern a plurality of electronic tags or transponders (hereinafter, referred to as tags) attached to objects, animals, etc., and an RFID reader or interrogator (hereinafter, referred to as an RFID reader unit) for reading and writing information that the tags include.

### SUMMARY OF THE INVENTION

The present invention provides a mobile Radio Frequency Identification (RFID) device and a data communication method thereof, which reduce an error of a command or response communicated between a mobile communication unit and an RFID reader unit.

Embodiments of the present invention provide data communication methods of a mobile RFID device including: providing, by a mobile communication terminal unit, a command to an mRFID reader unit and receiving a response to the command from the mRFID reader unit; and checking whether there is an error in a protocol message of the command or the response, and re-transmitting the command to the mRFID reader unit according to a check result.

In some embodiments, the command and the response may include a Cyclic Redundancy Check (CRC) field to check the error of the protocol message, respectively. The CRC field may follow an end mark field of the protocol message. The re-transmission number of the command may be limited to K (K is a natural number).

In other embodiments of the present invention, mobile RFID devices include: a mobile communication terminal unit providing a command; and an mRFID reader unit providing a response to the command to the mobile communication terminal unit, wherein the communication terminal unit and the mRFID reader unit include a CRC circuit to check whether there is an error in a protocol message of the command or the response, respectively, and the communication terminal unit re-transmits the command to the mRFID reader unit according to a result of the error check.

In some embodiments, the command and the response may include a CRC field to check the error of the protocol message, respectively.

In other embodiments, the command may be a set security key command, and the set security key command may include information on an Electronic Serial Number (ESN), a phone number, and a user assignment key. The command may be a set frequency mode command, and the set frequency mode command may include information on a frequency hopping mode, a Listen before Talk (LbT) mode, or a specific frequency use. The command may be a set Medium Access Control (MAC) control command, and the set MAC control command may include information on whether a MAC is used. The command may be a start automatic read command, and the start automatic read command may include information on a maximum number of tags, a tagging maximum duration, and a repeat cycle.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a block diagram illustrating a mobile RFID device according to an embodiment of the present invention;

FIGS. 2 and 3 are diagrams illustrating a protocol message structure of a command and a response shown in FIG. 1;

FIGS. 4 and 5 are diagrams illustrating payload types of the command and the response shown in FIG. 3;

FIG. 6 is a flowchart illustrating an operating method of the mobile RFID device shown in FIG. 1;

FIGS. 7 to 9 are diagrams illustrating an exemplary set security key command and response;

FIGS. 10 and 11 are diagrams illustrating an exemplary set frequency mode command and response;

FIGS. 12 and 13 are diagrams illustrating an exemplary set MAC control command and response;

FIGS. 14 to 16 are diagrams illustrating an exemplary start automatic read command and response;

FIGS. 17 to 22 are diagrams illustrating an exemplary start automatic read2 command and response;

FIGS. 23 and 24 are diagrams illustrating an exemplary stop automatic read2 command and response;

FIGS. 25 to 28 are diagrams illustrating an exemplary start automatic read3 command and response;

FIGS. 29 and 30 are diagrams illustrating an exemplary stop automatic read3 command and response;

FIGS. 31 and 32 are diagrams illustrating an exemplary read type C TID command and response; and

FIGS. 33 and 34 are flowchart illustrating a data communication method between a mobile communication terminal unit and an mRFID reader unit.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

I. Mobile Radio Frequency Identification (RFID) Device

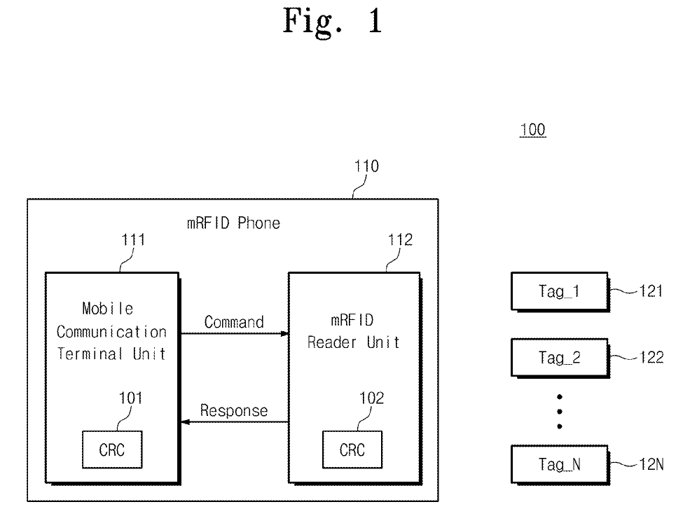

FIG. 1 is a block diagram illustrating a mobile RFID device according to an embodiment of the present invention. Referring to FIG. 1, a mobile RFID device 100 may include a mobile RFID phone (hereinafter, referred to as an mRFID phone) 110 and a plurality of tags 121 to 12N. Here, the mobile RFID device 100 may use other electronic devices such as Personal Digital Assistant (PDAs), Portable Multimedia Players (PMPs), or notebooks, which use RFID technology.

Referring to FIG. 1, the mRFID phone 110 may include a mobile communication terminal unit 111 and a mobile RFID reader unit (hereinafter, referred to as an mRFID reader unit) 112. The mobile communication terminal unit 111 may be connected to the mRFID reader unit 112 through hardware interfaces such as Universal Asynchronous Receiver/Transmitter (UART), Inter-Integrated Circuit (I2C), and Serial Peripheral Interface (SPI). The mobile communication terminal unit 111 may provide a command to the mRFID reader unit 112, and receive a response from the mRFID reader unit 112. The command and response communicated between the mobile communication terminal unit 111 and the mRFID reader unit 112 may be defined by protocols.

The mRFID reader unit 112 may communicate with the plurality of tags 121 to 12N using an Ultra High Frequency (UHF; from about 800 MHz to about 960 MHz) band among various radio communication equipment frequency bands for RFID/USN. On the other hand, the mRFID reader unit 112 may also use both a UHF (about 860 MHz to about 960 MHz) band and an HF (about 13.56 MHz) band. The mRFID reader unit 112 may also use a frequency occupation manner such as Frequency Hopping (FH) or Listen before Talk (LbT).

Referring again to FIG. 1, the mRFID phone 110 may include a Cyclic Redundancy Check (CRC) circuit 101 or 102 in the mobile communication terminal unit 111 or mRFID reader unit 112. Also, the mRFID phone 110 may also include a separate CRC circuit (not shown) outside the mobile communication terminal unit 111 and the mRFID reader unit 112. On the other hand, the mRFID reader unit 112 may be embedded into the mRFID phone 110 (see FIG. 1), or may be connected to the outside of the mRFID phone 110 in a dongle manner (not shown).

In a typical mRFID phone, when a battery is weak, incorrect commands or responses may be communicated between a mobile communication terminal unit and an mRFID reader unit. The incorrect commands or responses may cause malfunction of the mRFID phone. Since the mobile RFID device 100 according to an embodiment of the present invention includes the CRC circuits 101 and 102, the mobile RFID device 100 may prevent a malfunction due to an error of a command or response between the mobile communication terminal unit 111 and the mRFID reader unit 112.

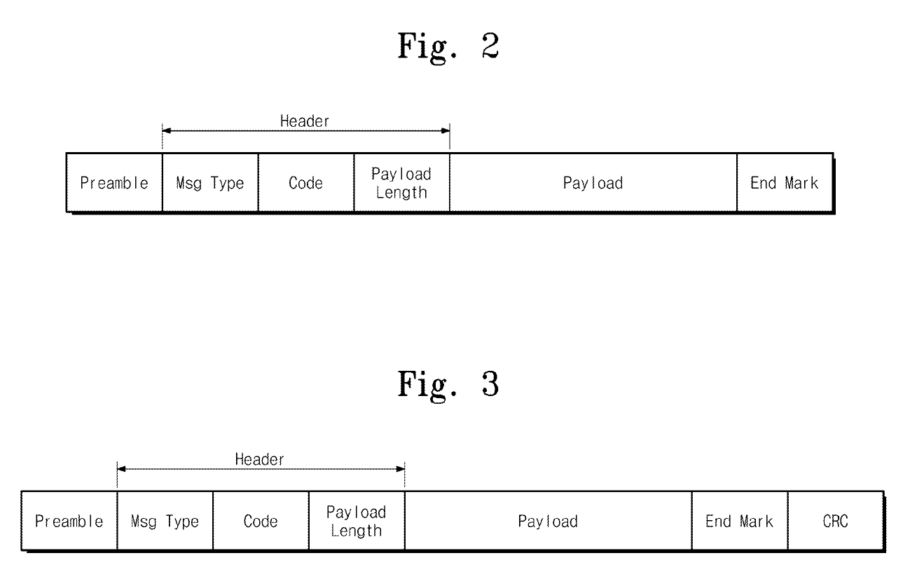

FIGS. 2 and 3 are diagrams illustrating a protocol message structure of a command and a response shown in FIG. 1. FIG. 2 illustrates a protocol message structure when a CRC circuit is not used, and FIG. 3 illustrates a protocol message structure when the CRC circuit is used. In FIG. 3, a CRC field is separately included in a protocol message. Referring to FIG. 3, the protocol message may include a preamble field, a header field, a payload field, an end mark field, and a CRC fields.

The preamble and end mark fields may indicate start and end of the protocol message. The preamble and the end mark field may be configured with 8-bit, respectively. The preamble field may be located at the initial part of the protocol message. The end mark field may be located at the last part of the protocol message (see FIG. 2), or may be located before the CRC field (see FIG. 3). The preamble and end mark fields may have certain values. For example, the preamble filed may have 0xBB, and the end mark field may have 0x7E. Here, 0xNNNN may represent the hexadecimal notation.

Referring again to FIG. 3, the header field may include a message type field, a code field, and a payload length filed. The message type field may indicate which of a command, response, or notification the protocol message corresponds to, and may be configured with a total of 8-bit. The code field may include information for distinguishing the type of the command or response. There are many types of commands to be processed by the mRFID reader unit (see FIG. 1) 112 and many types of responses corresponding thereto. Accordingly, if codes are assigned according to the type of commands and responses, the mRFID reader unit 112 may distinguish the commands and the responses by referring to the message type field and the code field. The payload length field may represent the length of the payload field just following the header field, and may be configured with 16-bit.

The payload field may store various types of data. The payload field may include arguments related to commands and responses. Various types of payloads may be used in the payload field in accordance with various commands and responses.

The protocol message may include a CRC field following the end mark field. The CRC field may be used to verify errors of massage bits included in commands and responses.

Referring again to FIG. 1, the mRFID reader unit 112 may calculate a CRC value of the command using the CRC circuit 102, and may verify whether the CRC value or checksum included in the command is valid. If the CRC value is invalid, the mRFID reader 112 may discard the command, or may not respond or take any action. In this case, the mRFID reader unit 112 may send a response including a code field and a result code (e.g., 0xFF) to the mobile communication terminal unit (111 of FIG. 1). Then, the mobile communication terminal unit 111 may re-send the command.

Similarly, the CRC circuit (101 of FIG. 1) may calculate a CRC value of the response, and may verify whether the CRC value or checksum included in the response is valid. If the CRC value is invalid, the mobile communication terminal unit 111 may discard the response, or may re-send the command within a limited retransmission number.

The CRC value may be calculated by various methods. For example, a 16-bit CRC value (CRC-16) may be calculated using all message bits ranging from the message type to the end mark field. For example, the CRC value may be calculated by a polynomial expressed as Equation (1).

CRCvalue=X¹⁶+X¹²+X⁵+1 (1)

A CRC value may be preloaded to the CRC circuits 101 and 102 as 0xFFFF. The CRC value may be reversed, added to the next of the end mark field, and transmitted. The most significant byte of the CRC value may be first transmitted, and the most significant bit of the respective bytes may be first transmitted.

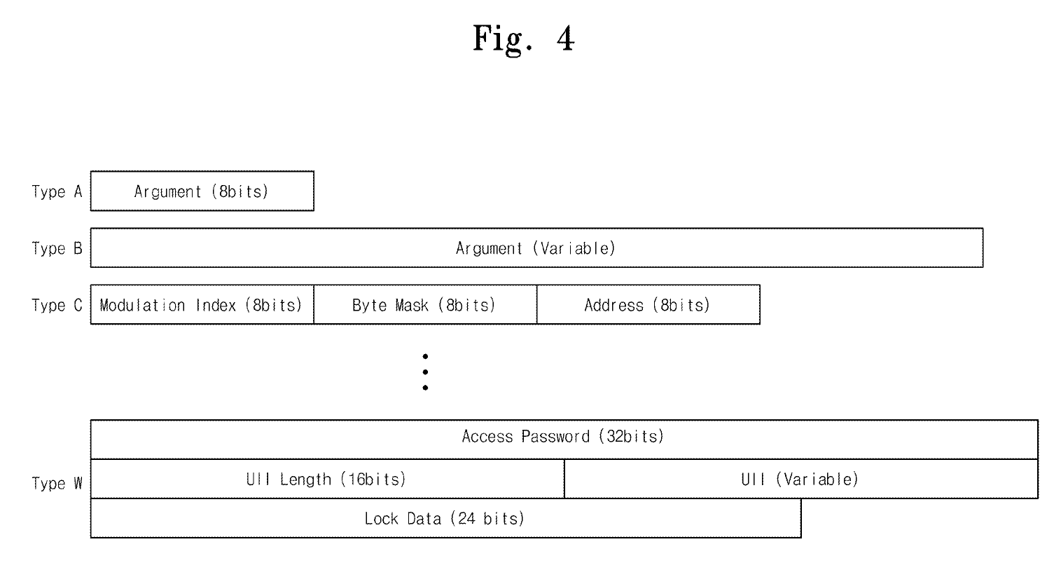

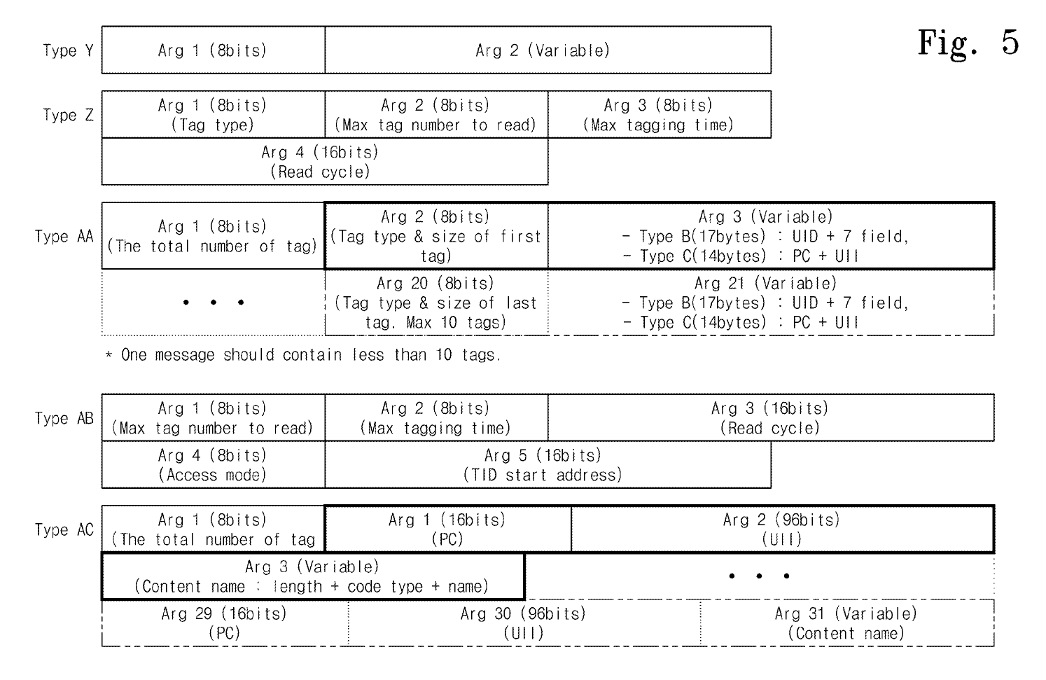

FIG. 4 shows various payload types from a type A to a type AC. As shown in FIGS. 4 and 5, the payload types A to AC may include unique filed, respectively.

Referring to FIG. 4, the payload type A may be configured with an 8-bit argument. The payload type B may be configured with an argument having a variable size. The payload C may be configured with an 8-bit modulation index, an 8-bit byte mask, and an 8-bit address. The payload type W may be configured with a 32-bit access password, a 16-bit Unique Item Identifier (UII) length, and a UII of variable size, and a 24-bit lock data.

Referring to FIG. 5, the payload type Y may be configured with an 8-bit argument Arg1 and an argument (Arg2) of a variable size. The payload type Z may be configured with 8-bit arguments Arg1 to Arg3 and a 16-bit argument Arg4. The payload type AA may be configured with arguments Arg1 to Arg21. In the payload type AA, the argument Arg1 denotes the number of tags. One message should contain less than 10 tags. The payload type AB may be configured with arguments Arg1 to Arg 5. The arguments Arg1 to Arg 5 may represent the maximum number of tags to be read, the maximum tagging time, a read cycle, an access mode, and a TID start address. The payload type AC may be configured with arguments Arg1 to Arg 31. The arguments Arg1 to Arg 31 may include the maximum number of tags, PC, UII, and a content name.

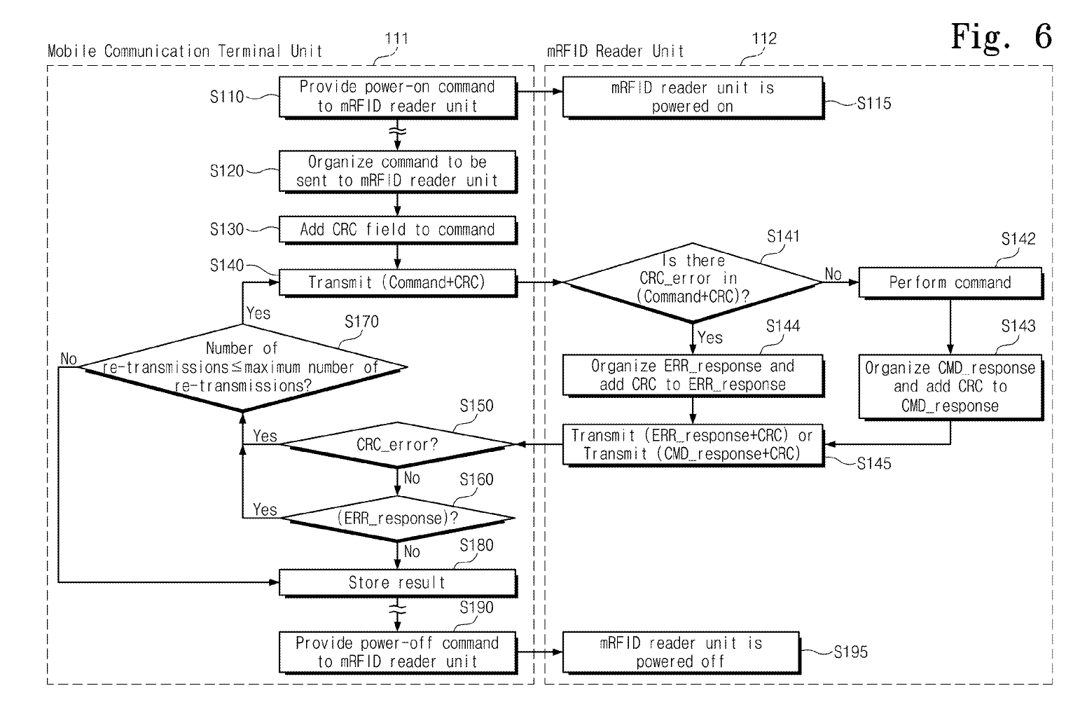

FIG. 6 is a flowchart for describing a communication method between the mobile communication terminal unit 111 and the mRFID reader unit 112 of the mobile RFID device 100 shown in FIG. 1. Referring to FIGS. 1 and 6, a method for operating the mobile RFID device 100 according to an embodiment of the present invention will be described.

In operation S110, the mobile communication terminal unit 111 may provide a power-on command to the mRFID reader unit 112 according to a user's request. In operation S115, the mRFID reader unit 112 may be powered on by the power-on command.

In operation S120, the mobile communication terminal unit 111 may organize a command to be sent to the mRFID reader unit 112. Here, the command may have a protocol message structure described in FIG. 2. The command may contain contents related to a reader control/manage, a tag read, a tag write, a tag lock/unlock, a tag erase, and other additional functions.

In operation S130, the mobile communication terminal unit 111 may add a CRC field to the command. The CRC field may be added to the next of the end mark field as described in FIG. 3. In operation S140, the mobile communication terminal unit 111 may transmit the command Command+CRC including the CRC field to the mRFID reader unit 112.

In operation S141, the mRFID reader unit 112 may receive the command from the mobile communication terminal unit 111, and may perform a CRC test. The mRFID reader unit 112 may determine whether there is a CRC error.

When there is no CRC error, operation S142 is performed. In operation S142, the mRFID reader unit 112 may execute the command received from the mobile communication terminal unit 111. In operation S143, the mRFID reader unit 112 may organize a response (hereinafter, referred to as a CMD_response) in accordance with the command execution. The mRFID reader unit 112 may add a CRC field to the CMD_response. The CRC field may be added to the next of the end mark field as described in FIG. 3. In operation S145, the mRFID reader unit 112 may transmit a CMD response (CMD_response+CRC) including the CRC field to the mobile communication terminal unit 111.

In operation S141, if there is a CRC error, operation S144 is performed. In operation S144, the mRFID reader unit 112 may organize a response (hereinafter, referred to as an ERR_response) in accordance with the CRC error. The mRFID reader unit 112 may add a CRC field to the ERR_response. In operation S145, the mRFID reader unit 112 may transmit the ERR_response (ERR_response+CRC) including the CRC field to the mobile communication terminal unit 111.

In operation S150, the mobile communication terminal unit 111 may receive a response (ERR_response or CMD_response) from the mRFID response, and may perform a CRC test. The mobile communication terminal unit 111 may determine whether there is a CRC error in the received response ERR_response or CMD_response from the mRFID reader unit 112.

If there is no CRC error (i.e., ERR_response+CRC or CMD_response+CRC), operation S160 may be performed. In operation S160, the mobile communication terminal unit 111 may determine whether the response received from the mRFID reader unit 112 is an ERR_response. If the response is not an ERR_response but a CMD_response, a result is stored in operation S180. If there is a CRC error in operation S150, or the response is an ERR_response in operation S160, the process of retransmitting the command may be performed in operations S170 and S140.

In operation S170, it is determined whether the number of command retransmission is smaller than or equal to the maximum number of retransmission. The mobile communication terminal unit 111 may store the maximum number of retransmission in advance, and may count the number of retransmitted commands. If the number of retransmission is smaller than or equal to the maximum number of retransmission, a command including a CRC field may be retransmitted in operation S140. If the number of retransmission is greater than the maximum number of retransmission, a result may be stored in operation S180.

In operation S190, the mobile communication terminal unit 111 may provide a power-off command to the mRFID reader unit 112 according to a user's request. In operation S195, the mRFID reader unit 112 may be powered off in response to the power-off command.

Referring again to FIG. 1, the mobile RFID device 100 according to an embodiment of the present invention may check errors of the command and the response, using the CRC circuits 101 and 102 and the CRC field. According to an embodiment, malfunction of the mobile RFID device 100 due to an error of the command and the response may be prevented.

Hereinafter, various commands and responses communicated between the mobile communication terminal unit 111 and the mRFID reader unit 112 described in FIG. 1 will be described. A protocol message of a command and a response may include a CRC field.

II. Embodiment of Command and Response

1. Set Security Key

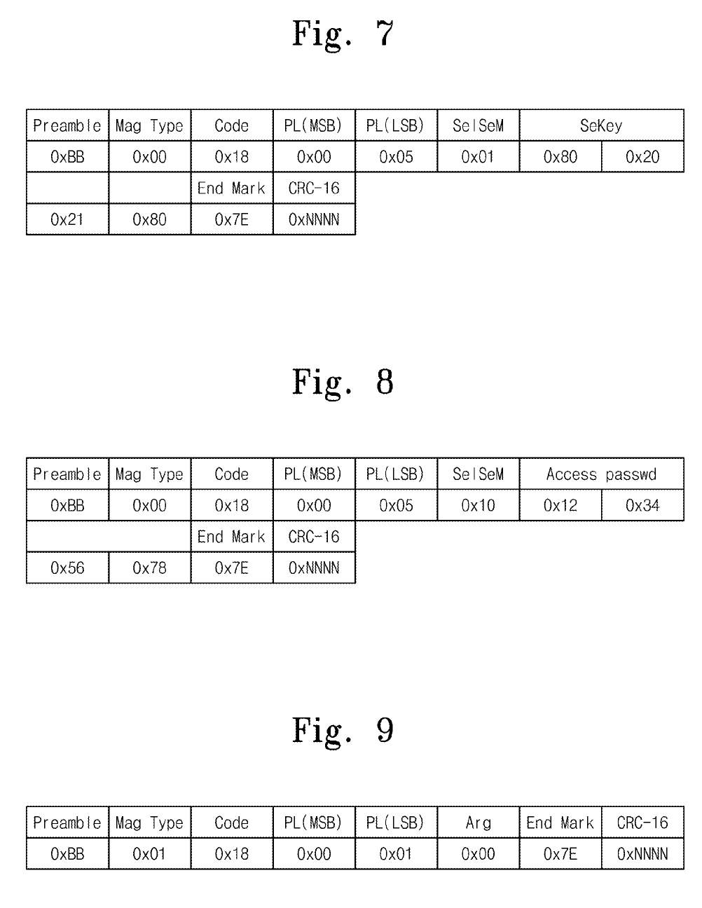

FIGS. 7 to 9 show an exemplary set security key command and response. Referring to FIGS. 7 to 9, the set security key command and response may include a CRC field following an end mark field. A value of the CRC field may be exemplarily expressed as 0xNNNN.

Referring to FIGS. 7 and 8, the sec security key command may concern ISO 18000-6 Type C Protocol, and may be used to set a security key and access a password. The set security key command may include a message type, a code, a payload length, and an argument. The message type may be expressed as 0x00 indicative of command. The code may be expressed as 0x18 indicative of set security key. The payload type may be expressed by the payload type Y (see FIG. 5).

The argument may include an 8-bit select security mode SelSeM to be sent to the tag and a 32-bit security key value SeKey or an access password (see FIG. 8). Referring to FIG. 7, the select security mode SelSeM value may be expressed as 0x00 when a data security mode is in a disabled state (default). The select security mode SelSeM value may be expressed as 0x01 when the data security mode is in an enabled state. In FIG. 7, the select security mode SelSeM may be expressed as 0x01.

Referring to FIG. 8, the select security mode SelSeM value may be expressed as 0x10 in case of accessing a password for a reserved memory bank of the tag, while the security mode is in the disabled state. The select security mode SelSeM value may be expressed as 0x11 in case of accessing a password of the tag, while the security mode is in the enabled state. In FIG. 8, the select security mode SelSeM may be expressed as 0x01.

In FIG. 7, the security key value SeKey may be an Electronic Serial Number (ESN), a phone number, and a user defined key. Referring to FIG. 7, the security key may be expressed as 0x80202180. Referring to FIG. 8, the access password may be expressed as 0x12345678.

FIG. 9 shows an exemplary structure of a response protocol message regarding to the set security key command. The response regarding to the set security key command may include a message type, a code, a payload length, and an argument. The message type may be expressed as 0x01 indicative of response. The code may be expressed as 0x18 in case of success, and may be expressed as 0xFF in case of failure. The payload type may be expressed by the payload type A (see FIG. 4).

The argument may be expressed as a result code 0x00 in case of success in the set security key command, and may be expressed as a result code 0x21 in case of failure in the set security key command. In case of not-supported command, the argument may be expressed as 0x17. In FIG. 9, the code may be expressed as 0x18, and the argument may be expressed as 0x00.

2. Set Frequency Mode

FIGS. 10 and 11 are diagrams illustrating an exemplary set frequency mode command and response. Referring to FIGS. 10 and 11, the set security key command and response may include a CRC field following an end mark field. The set frequency mode command may be used to set a frequency mode or a special frequency mode.

Referring to FIG. 10, the set frequency mode command may include a message type, a code, a payload length, and an argument. The message type msg type may be expressed as 0x00 indicative of command. The code may be expressed as 0x19 indicative of set frequency mode. A payload type may be expressed by the payload type 0 (not shown in FIG. 4). The payload type 0 may be configured with an 8-bit argument Arg1 and an 8-, 16-, 24-, or 32-bit argument Arg2.

Referring to FIG. 10, the argument may be configured with an 8-bit Arg1 SelFM and a 24-bit Arg2. Arg1 may represent a select frequency mode SelFM. For example, Arg1 may be expressed as 0x00 (default) when the select frequency mode SelFM is a frequency hopping mode, may be expressed as 0x01 when the select frequency mode SelFM is an LbT mode, and may be expressed as 0x02 when the select frequency mode SelFM is a special frequency. In FIG. 10, Arg1 is expressed as 0x02. Arg2 may define an LbT threshold (dBm unit) when Arg1 is 0x01, and may define frequency (kHz unit) when Arg1 is 0x02. In FIG. 10, the frequency is expressed as 0x0E0A3D (about 920.125 MHz).

FIG. 11 shows an exemplary structure of a response protocol message regarding the set frequency mode command. The response to the set frequency mode command may include a message type, a code, a payload length, and an argument. The message type may be expressed as 0x01 indicative of response. The code may be expressed as 0x19 in case of success, and may be expressed as 0xFF in case of failure. The payload type may be expressed by the payload type A (see FIG. 4).

In case of success, the argument Arg may be expressed by a result code 0x00, and, in case of failure, may be expressed as a result code 0x22. In case of not-supported command, the argument may be expressed as 0x17.

3. Set Medium Access Control (MAC) Control

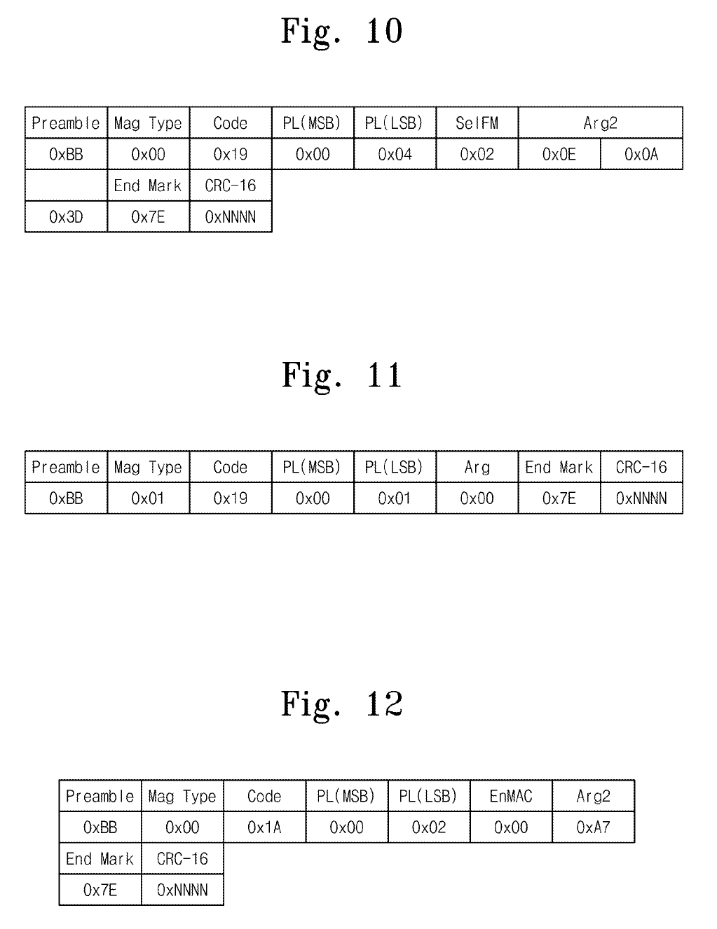

FIGS. 12 and 13 are diagrams illustrating an exemplary set MAC control command and response. Referring to FIGS. 12 and 13, the sec MAC control command and response may include a CRC field following an end mark field.

FIG. 12 shows an exemplary structure of a protocol message for the set MAC control command. The sec MAC control command may be used to set MAC related to, especially, ISO/IEC 29143. The set MAC control command may include a message type, a code, a payload length, and an argument. The message type may be expressed as 0x00 indicative of command. The code may be expressed as 0x1A indicative of set MAC control. The pay load type may be expressed by the payload type 0 (not shown in FIG. 4).

The argument may be configured with an 8-bit Arg1 EnMAC and an 8-bit Arg2. Arg 1 may be used to enable or disable a MAC function EnMAC. For example, Arg1 may be expressed as 0x00 (default) when enabling the MAC function, and may be expressed as 0x01 when disabling the MAC function. In FIG. 12, EnMAC is expressed as 0x00.

4-bit MSB of Arg2 may be used to represent an amplitude threshold of an interference interrogator, having a range from 0x0 (0%) to 0xA (100%, default). 4-bit LSB of Arg2 may be used to represent an average threshold of a collision count, having a range from 0x0 to 0xF (default is 0x7). In FIG. 12, a protocol message is shown when EnMAC is 0x00, and the amplitude threshold of the interference interrogator is 0xA, and the average threshold of the collision count is 0x7.

FIG. 13 shows an exemplary structure of a response protocol message regarding the set MAC control command. The response to the set MAC control command may include a message type, a code, a payload length, and an argument. The message type may be expressed as 0x01 indicative of response. The code may be expressed as 0x1A in case of success, and may be expressed as 0xFF in case of failure. The payload type may be expressed by the payload type A (see FIG. 4).

In case of success, the argument Arg may be expressed by a result code 0x00, and, in case of failure, may be expressed as a result code 0x23. In case of not-supported command, the argument may be expressed as 0x17.

4. Start Automatic Read

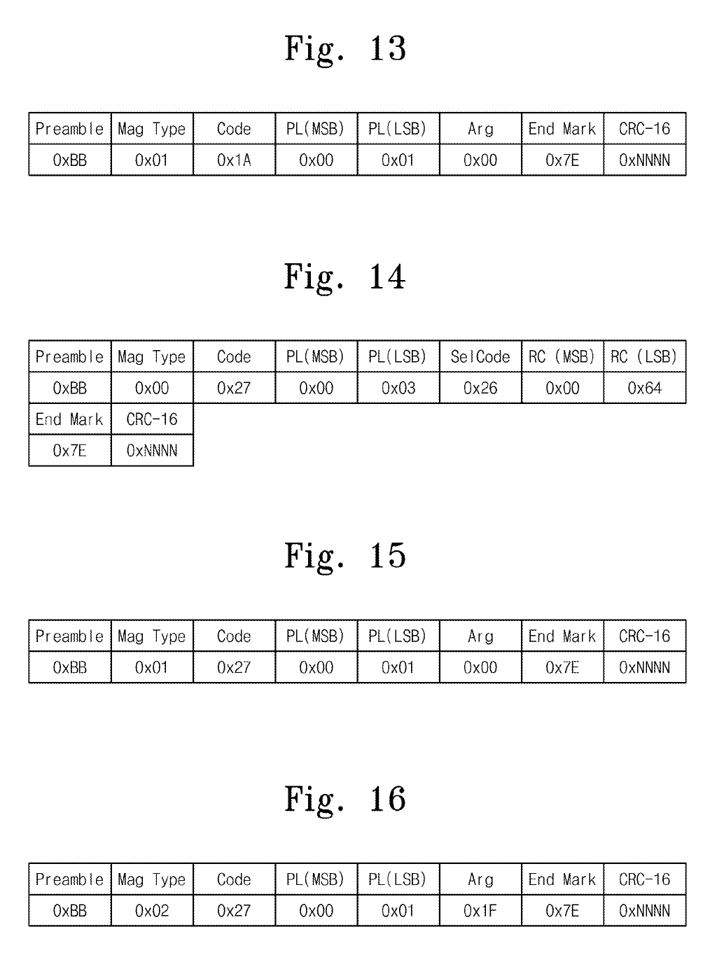

FIGS. 14 to 16 are diagrams illustrating an exemplary start automatic read command and response. Referring to FIGS. 14 to 16, the start automatic read command and response may include a CRC field following an end mark field.

FIG. 14 shows an exemplary structure of a protocol message for the start automatic read command. The start automatic read command may be used to start an automatic tag read operation. The start automatic read command may include a message type, a code, a payload length, and an argument. The message type may be expressed as 0x00 indicative of command. The code may be expressed as 0x27 indicative of start automatic read. The payload type may be expressed by the payload type 0 (Arg2 is 16-bit).

The argument may be configured with an 8-bit command code SelCode and a 16-bit repeat cycle RC. The 8-bit command code SelCode may be for performing an automatic read operation. The command code may have a range from 0x21 to 0x26 except which an automatic read operation may not be performed. The number of read cycles may equal to the number of inventory rounds of a tag. The repeat cycle RC may indicate iteration number of the read cycles. In FIG. 14 a protocol message is shown when the command code SelCode is 0x26, and the repeat cycle RC is 0x0064.

FIG. 15 shows an exemplary structure of a response protocol message regarding the start automatic read command. The response to the start automatic read command may include a message type, a code, a payload length, and an argument. The message type may be expressed as 0x01 indicative of response. The code may be expressed as 0x27 in case of success, and may be expressed as 0xFF in case of failure. The payload type may be expressed by the payload type A (see FIG. 4).

In case of success, the argument Arg may be expressed by a result code 0x00, and, in case of failure, may be expressed as a result code 0x0A. The argument Arg may be expressed as a result code 0x0E unless the command code SelCode is within a range of 0x21 to 0x26. Also, the argument Arg may be expressed as a result code 0x0E unless the repeat cycle RC is zero. The argument may be expressed as a result code 0x0B when the automatic read operation is performed.

FIG. 16 is an exemplary structure of a notification protocol message informing that an automatic read operation has been completed. When data read from a tag is delivered, the notification protocol message may match a response corresponding to a command code 0x21 to 0x26.

A notification message may include a message type, a code, a payload length, and an argument. The message type may be expressed as 0x02 indicative of notification. The code may match a code used in a start automatic read command. When data read from the tag is delivered, the payload type may match a response corresponding to the command code 0x21 to 0x26. When an automatic read operation is completed by repeating the automatic read operation predetermined times, the payload type may be expressed by the payload type (see FIG. 4).

When data read from the tag is delivered, the argument may match a response corresponding to the command code 0x21 to 0x26. When the automatic read operation is completed by repeating the automatic read operation predetermined times, the argument may include a result code 0x1F. When there is no more tag to be read, the argument may include a result code 0x20.

5. Start Automatic Read2

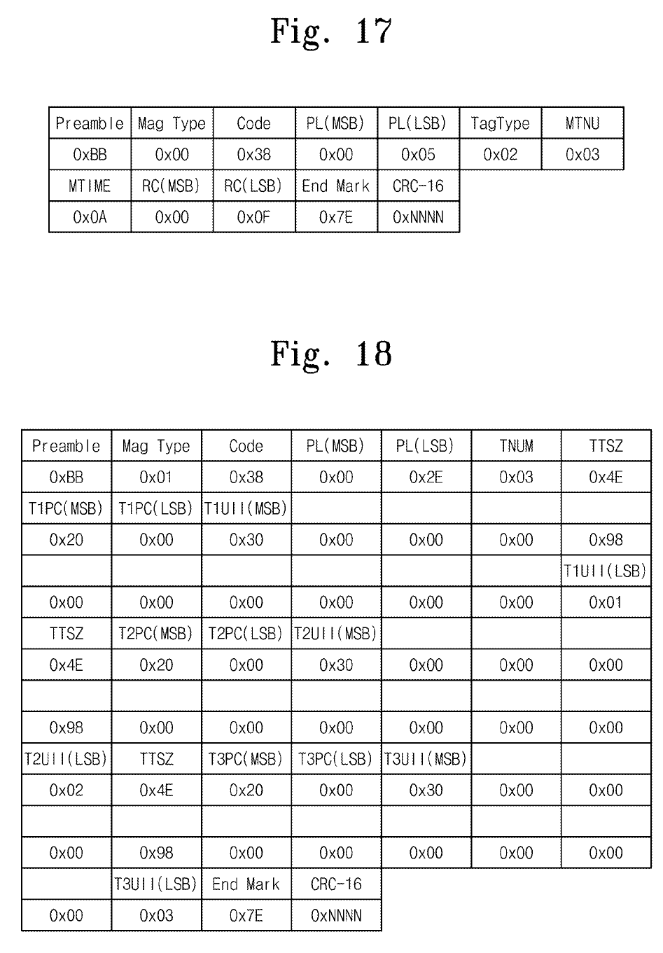

FIGS. 17 to 20 are diagrams illustrating an exemplary start automatic read2 command and response. Referring to FIGS. 17 to 20, the start automatic read2 command and response may include a CRC field following an end mark field.

FIG. 17 shows an exemplary structure of a protocol message for the start automatic read2 command. The start automatic read2 command may be used in reading all types of tags with the automatic read operation. Particularly, the response to this command may send IDs of a maximum of 10 tags to the mobile communication terminal unit (111 of FIG. 1).

The start automatic read2 command may include a message type, a code, a payload length, and an argument. The message type may be expressed as 0x00 indicative of command. The code may be expressed as 0x38 indicative of start automatic read2. The payload type may be expressed by the payload type Z (see FIG. 5).

The argument may be configured with an 8-bit tag type Tagtype, a tag read maximum number MTNU, a tag read maximum duration MTIME, and a repeat cycle RC. The tag type TagType may be expressed as 0x01 when reading a unique identifier UID of a type B tag, and may be expressed as 0x02 when reading a unique item identifier UII bank. The tag type TagType may be expressed as 0xFF when reading all types of tags automatically.

When tagging is performed as many as the repeat cycle regardless of the number of tags, the tag read maximum number MTNU may be expressed as 0x00 (default). Values other than 0x00 may represent the maximum number of tags to be read. The tag read maximum duration MTIME may be expressed as 0x00 when tagging is performed as many as the repeat cycle regardless of this field. 0x01 to 0xFE may represent tagging duration of second unit. 0xFF may be used in tagging without being limited to time until the stop automatic read2 command. The repeat cycle RC may be identical to that of the start automatic read command, and may represent the iteration number of the read cycles. Priorities among MTNU, MTIME, and RC may be expressed as MTNU>MTIME>RC. MTNU may have the highest priority.

In FIG. 17, a protocol message is shown when the tag type TagType is 0x02, the maximum number MTNUM of tags to be read is 0x03 (three tags), the tag read maximum duration MTIME is 0x0A (10 seconds), and the repeat cycle RC is 0x0F.

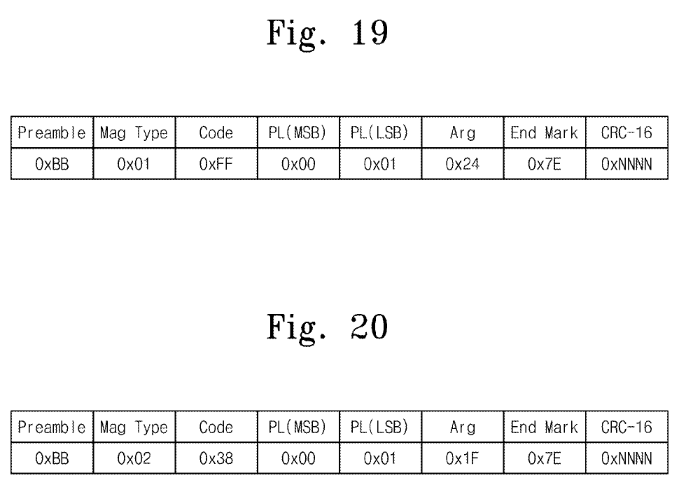

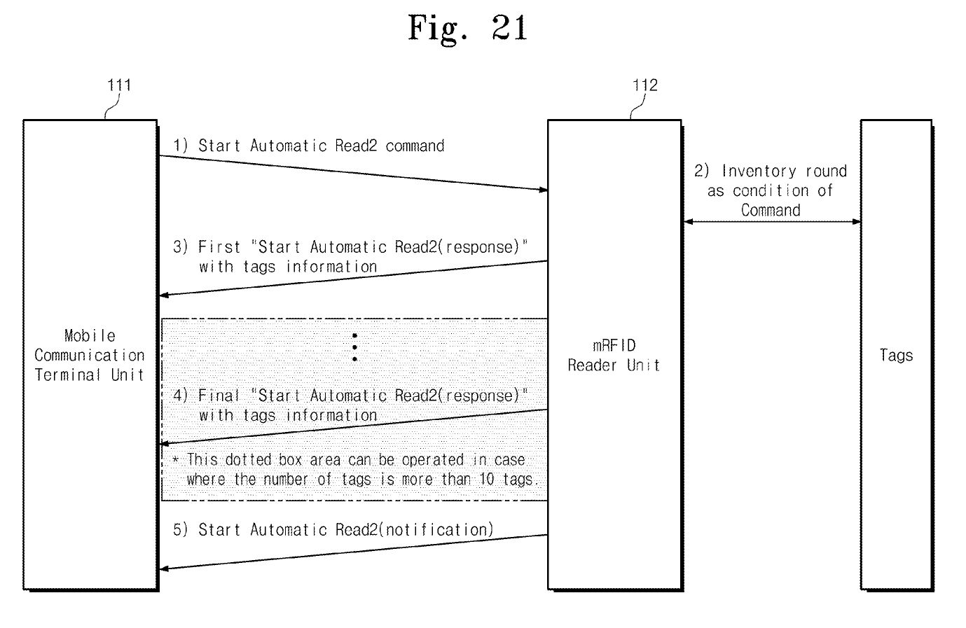

On the other hand, a message that delivered from the mRFID reader unit (112 of FIG. 1) to the mobile communication terminal unit (111 of FIG. 1) may include two types of responses and one type of notification. FIGS. 18 and 19 show examples of responses, and FIG. 20 shows an example of notification.

FIG. 18 shows an exemplary structure of a protocol message of a start automatic read2 response when the RFID reader unit succeeds in tagging. The response to the start automatic read2 command may include a message type, a code, a payload length, and an argument. The message type may be expressed as 0x01 indicative of response. The code may be expressed as 0x38 in case of success, and may be expressed as 0xFF in case of failure. The payload type may be expressed by the payload type AA (see FIG. 5).

The first argument Arg1 of the payload, TNUM may represent the number of tags include in a response message. Accordingly, the size of the response message may depend on TNUM. TNUM may be smaller than 10. If the RFID reader unit 112 reads ten or more tags, the RFID reader unit 112 should repeatedly send the response message per 10 tags. For example, if RFID reader unit 112 reads 35 tags, the mRFID reader unit 112 should send the response message to the mobile communication terminal unit 111 four times.

The second argument Arg2 of the payload, TTSZ may be configured with 8-bit. 3-bit among 8-bit may represent a tag type, and 5-bit may represent a tag byte size. The 3-bit tag type may be expressed as 0x0a in case of a tag type B, and may be expressed as 0x02 in case of a tag type C. Other values may be reserved for future.

In FIG. 18, the number TNUM of tags may be 0x03. The type and size TTSZ of a tag 1 may be 0x4E, and PC of the tag 1 may be 0x2000. UII of the tag 1 may be 0x300000009800000000000001. The type and size TTSZ of a tag 2 may be 0x4E, and PC of the tag 2 may be 0x2000. UII of the tag 2 may be 0x300000009800000000000002. The type and size TTSZ of a tag 3 may be 0x4E, and PC of the tag 2 may be 0x2000. UII of the tag 2 may be 0x300000009800000000000003.

FIG. 19 shows an exemplary structure of a protocol message of a start automatic read2 response when the mRFID reader unit fails in tagging. Referring to FIG. 19, a code may be 0xFF. The argument Arg may be expressed as a result code 0x0E in case of an invalid parameter, may be expressed as a result code 0x15 when a tag is not detected, may be expressed as a result code 0x17 in case of not-supported command, and may be expressed as a result code 0x24 in case of command failure. In FIG. 19, the argument may be expressed as 0x24.

FIG. 20 shows an exemplary structure of a notification protocol message informing that an automatic read2 operation has been completed. The notification message may be used in a start automatic read2 operation. The notification message may include a message type, a code, a payload, and an argument.

Referring to FIG. 20, the message type may be expressed as 0x02 indicative of notification. When the automatic read2 operation is completed under predetermined conditions, the mRFID reader unit 111 may send an argument Arg including a result code 0x1F to the mobile communication terminal 111. When there are no more tags to be read, the argument may include a result code 0x20. In FIG. 20, the argument Arg may be expressed as 0x1F.

FIG. 21 is a flowchart illustrating a start automatic read2 operation between the mobile communication terminal unit 111 and the mRFID reader unit 112 when a start automatic read2 command is successful. Referring to FIG. 21, the start automatic read2 operation may proceed as follows.

1) A start automatic read2 command may be provide from the mobile communication terminal unit 111 to the mRFID reader unit 112. 2) An inventory round may be performed according to conditions of commands between the mRFID reader unit 112 and the tag. 3) A start automatic read2 response including tag information may be provided from the mRFID reader unit 112 to the mobile communication terminal unit 111. 3) When the number of tags is more than 10, a start automatic read2 response may be repeatedly provided in unit of 10 tags. 4) The start automatic read2 response include tag information may be finally provided. 5) A notification may be provided that a start automatic2 operation has been completed from the mRFID reader unit 112 to the mobile communication terminal 111.

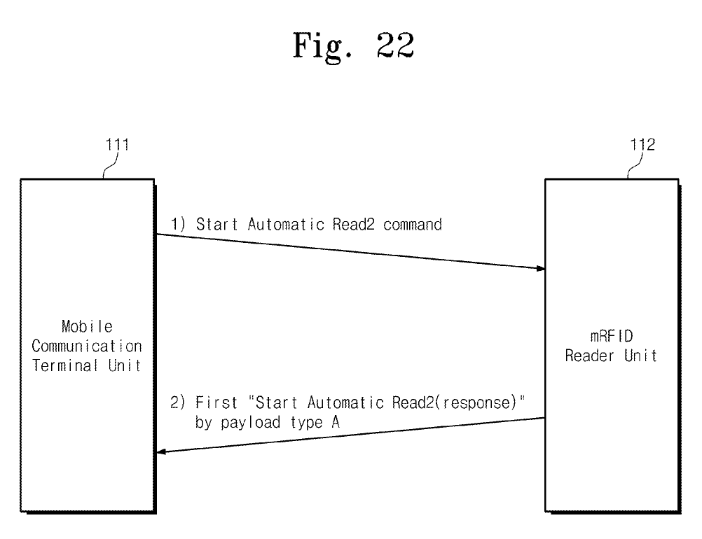

FIG. 22 is a flowchart illustrating a start automatic read2 operation between the mobile communication terminal unit 111 and the mRFID reader unit 112 when the start automatic read2 command fails.

Referring to FIG. 22, the start automatic read2 operation may progress in the following order. 1) A start automatic read2 operation may be provided from the mobile communication terminal unit 111 to the mRFID reader unit 112. 2) A start automatic read2 response may be provided by the payload type A (See FIGS. 4 and 20) from the mobile communication terminal unit 111 to the mRFID reader unit 112.

6. Stop Automatic Read2

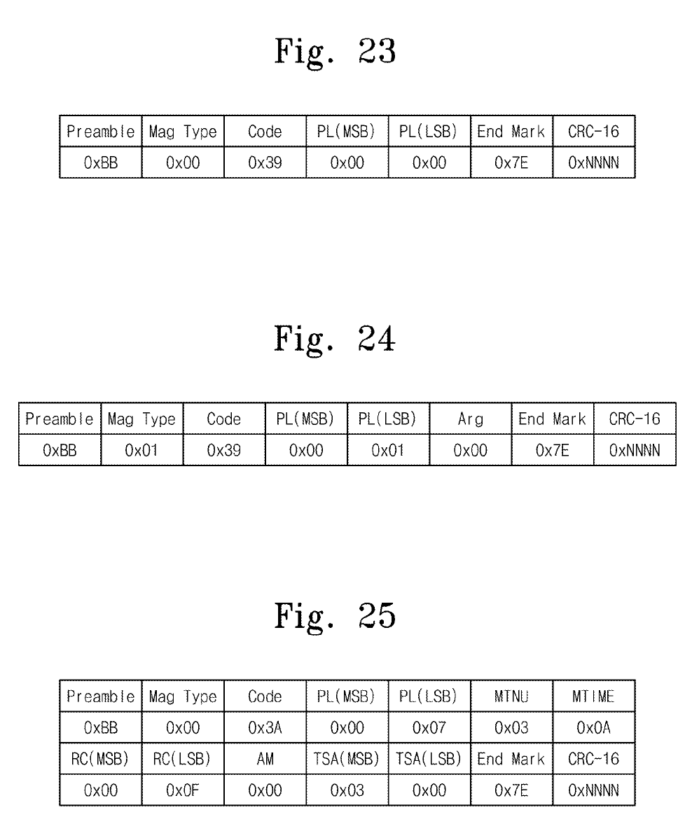

FIGS. 23 and 24 are diagrams illustrating an exemplary stop automatic read2 command and response. Referring to FIGS. 23 and 24, the stop automatic read2 command and response may include a CRC field following an end mark field.

FIG. 23 shows an exemplary protocol message structure for the stop automatic read2 command. The stop automatic read2 command may be used to stop the automatic read2 operation. The stop automatic read2 command may include a message type, a code, and payload length PL, but may not include an argument. The message type msg type may be expressed as 0x00 indicative of command. The code may be expressed as 0x39 indicative of stop automatic read2.

FIG. 24 shows a protocol message structure of the stop automatic read2 response when the RFID reader unit is successful in tagging. The response to the stop automatic read2 command may include a message type, a code, a payload length, and an argument. The message type may be expressed as 0x01 indicative of response. The code may be expressed as 0x39 in case of success, but may be expressed as 0xFF in case of failure. The payload type may be expressed by the payload type A (see FIG. 4).

The argument Arg may be expressed as 0x00 in case of success, may be expressed as 0x0C in case of Cannot Stop Automatic Read, and may be expressed as 0x0D when the automatic read2 operation is not performed. In FIG. 24, the argument Arg may be expressed as 0x00.

7. Start Automatic Read3

FIGS. 25 to 28 are diagrams illustrating an exemplary start automatic read3 command and response. Referring to FIGS. 25 to 28, the start automatic read3 command and response may include a CRC field following an end mark field.

FIG. 25 shows an exemplary protocol structure for the start automatic read3 command. The start automatic read3 command may be used to read special data in a user memory and UII of a tag by automatic read operation, related to a C-type tag. Particularly, the response to the start automatic read3 command may simultaneously send information on a maximum of 10 tags to the mobile communication terminal (111 of FIG. 1).

The start automatic read3 command may include a message type, a code, a payload length, and an argument. The message type msg type may be expressed as 0x00 indicative of command. The code may be expressed as 0x3A indicative of start automatic read3. The payload type may be expressed by the payload type AB (see FIG. 5).

The argument Arg1 to Arg 5 may be configured with a tag read maximum number MTNU, a tag read maximum duration MTIME, a repeat cycle RC, a memory access mode AM, and a TID memory start address TSA.

When tagging is performed as many as the repeat cycle regardless of the number of tags, the tag read maximum number MTNU may be expressed as 0x00 (default). Values other than 0x00 may represent the maximum number of tags to be read.

The tag read maximum duration MTIME may be expressed as 0x00 when tagging is performed as many as the repeat cycle regardless of this field. 0x01 to 0xFE may represent tagging duration of second unit. 0xFF may be used in tagging without being limited to time until the stop automatic read3 command.

The repeat cycle RC may be identical to that of the start automatic read command, and may represent the iteration number of the read cycles. Priorities among MTNU, MTIME, and RC may be expressed as MTNU>MTIME>RC. MTNU may have the highest priority.

The memory access mode AM may be configured with 8-bit. The memory access mode AM may be expressed as 0x00 in case of an indirect access method that performs inventory and read separately, may be expressed as 0x01 in case of a direct access method that uses a flex_query command of the mRFID reader unit (112 of FIG. 1), and may be expressed as 0x02 in case of an auto accessing method. Other values may be reserved for future.

The TID start address TSA may be configured with 16-bit, and may represent a start address within a TID memory bank. 32-bit data in a start address of a TID memory may include a pointer of a content name field that exists in a user memory bank. Therefore, in the indirect memory access method, TSA may be required to find a location of a content name that exists in a user memory. In the direct memory access method, however, TSA may be ignored.

In FIG. 25, a protocol message is shown when the tag read maximum number MTNU is 0x03 (three tags), the tag read maximum duration MTIME is 0x0A (10 seconds), the repeat cycle RC is 0x0F, the access mode AM is 0x00 (indirect access mode), and the TID start address is 0x0300.

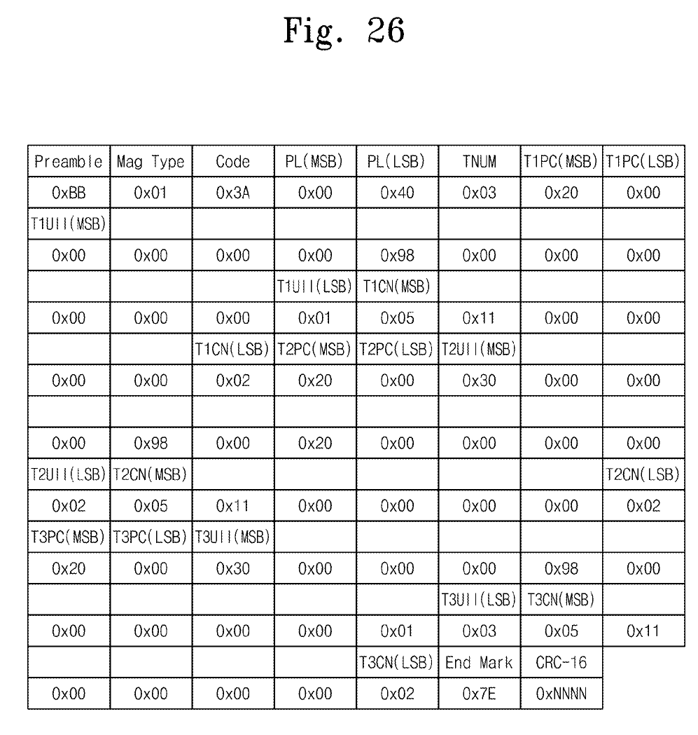

On the other hand, a message delivered from the mRFID reader unit 112 to the mobile communication terminal unit 111 may include two types of responses and one type of notification. FIGS. 26 and 27 show examples of responses, and FIG. 28 shows an example of a notification.

FIG. 26 shows a protocol message structure of a start automatic read3 response when the mRFID reader unit 112 is successful in tagging. The response to the start automatic read3 command may include a message type, a code, a payload length, and an argument. The message type may be expressed as 0x01 indicative of response. The code may be expressed as 0x3A in case of success, and may be expressed as 0xFF in case of failure. The payload type may be expressed by the payload type AC (see FIG. 5).

In payload, a first argument Arg1, TNUM may represent the number of tags included in a response message. Accordingly, the size of the response message may depend on TNUM. TNUM may be smaller than 10. If the mRFID reader unit 112 reads 10 tags or more, a response message is again sent from a tag every 10 tags. For example, if the mRFID reader unit 112 reads 35 tags, the mRFID reader unit 112 sends four response messages to the mobile communication terminal unit 111.

A second argument Arg2 may represent a 16-bit PC, a 96-bit UII, and a variable content name. MSB 8-bit of TICN may include the length of a content name in the first tag, and next 8-bit may represent the ASCII code type of content name characters. An argument like T1PC, T1UII, and T1CN may be repeated in one message ten times or less.

Referring to FIG. 26, the number TNUM of tags may be 0x03. PC (T1PC) of a tag 1 may be 0x2000. UII (T1UII) of the tag 1 may be 0x300000009800000000000001. The content name T1CN of the tag 1 may be 0x05110000000002. PC (T2PC) of a tag 2 may be 0x2000. UII (T2UII) of the tag 2 may be 0x300000009800000000000002. The content name T2CN of the tag 2 may be 0x05110000000002. PC (T3PC) of a tag 3 may be 0x2000. UII (T3UII) of the tag 3 may be 0x300000009800000000000003. The content name T3CN of the tag 2 may be 0x05110000000002.

FIG. 27 shows a protocol message structure of a start automatic read3 response when the mRFID reader unit 112 fails in tagging. Referring to FIG. 27, the code may be expressed as 0xFF. The argument Arg may be expressed as 0x0E in case of invalid parameter, may be expressed as 0x15 when a tag is not detected, may be expressed as a result code 0x17 in case of not-supported command, and may be expressed as 0x25 in case of command failure. In FIG. 27, the argument Arg may be expressed as 0x25.

FIG. 28 shows an exemplary notification protocol message structure informing that the automatic read3 operation has been completed. The notification message may be used in the start automatic read3 operation.

The notification message may include a message type, a code, a payload length, and an argument. The message type may be expressed as 0x02 indicative of notification. The argument may be expressed as 0x1F when the automatic read3 operation has been performed according to predetermined condition to complete the automatic read operation, and may be expressed as 0x20 when there is no more tag to be read.

8. Stop Automatic Read3

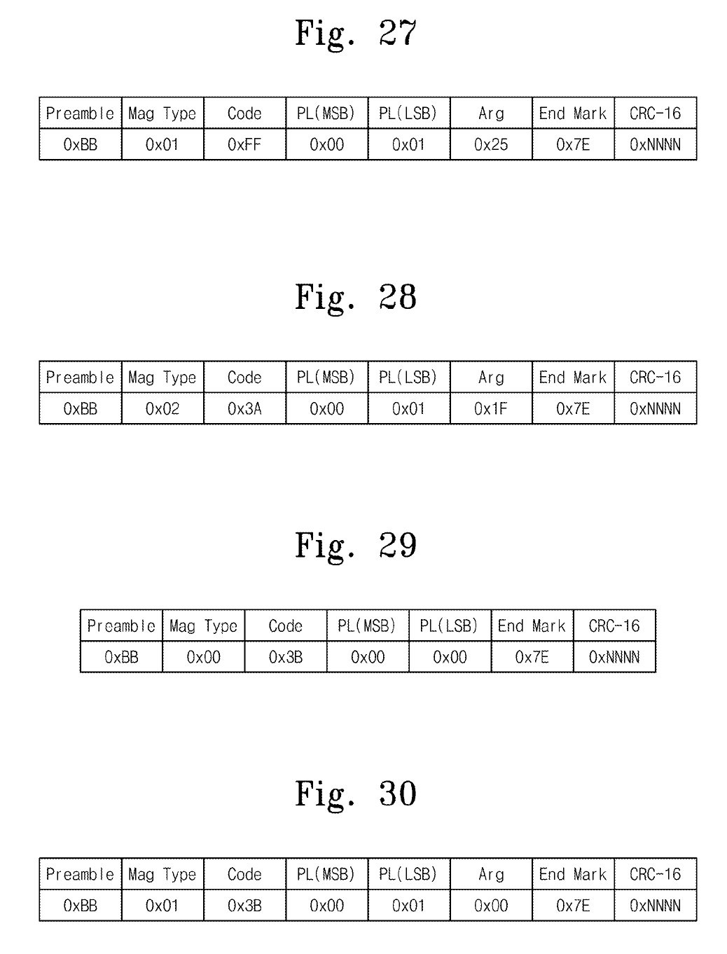

FIGS. 29 and 30 are diagrams illustrating an exemplary stop automatic read3 command and response. Referring to FIGS. 29 and 30, the stop automatic read3 command and response may include a CRC field following an end mark field.

FIG. 29 shows an exemplary protocol message structure for the stop automatic read3 command. The stop automatic read3 command may be used to stop an automatic read3 operation. The stop automatic read3 command may include a message type, a code, and a payload length PL. However, the stop automatic read3 command may not include an argument. The message type may be expressed as 0x00 indicative of command. The code may be expressed as 0x3B indicative of stop automatic read3.

FIG. 30 shows a protocol message structure of the stop automatic read3 response when the RFID reader unit 112 is successful in tagging. The response to the stop automatic read3 command may include a message type, a code, a payload length, and an argument. The message type may be expressed as 0x01 indicative of response. The code may be expressed as 0x3B in case of success, but may be expressed as 0xFF in case of failure. The payload type may be expressed by the payload type A (see FIG. 4).

The argument Arg may be expressed as 0x00 in case of success, may be expressed as 0x0C in case of Cannot Stop Automatic Read3, and may be expressed as 0x0D when the automatic read3 operation is not performed. In FIG. 30, the argument Arg may be expressed as 0x00.

9. Read Type TID

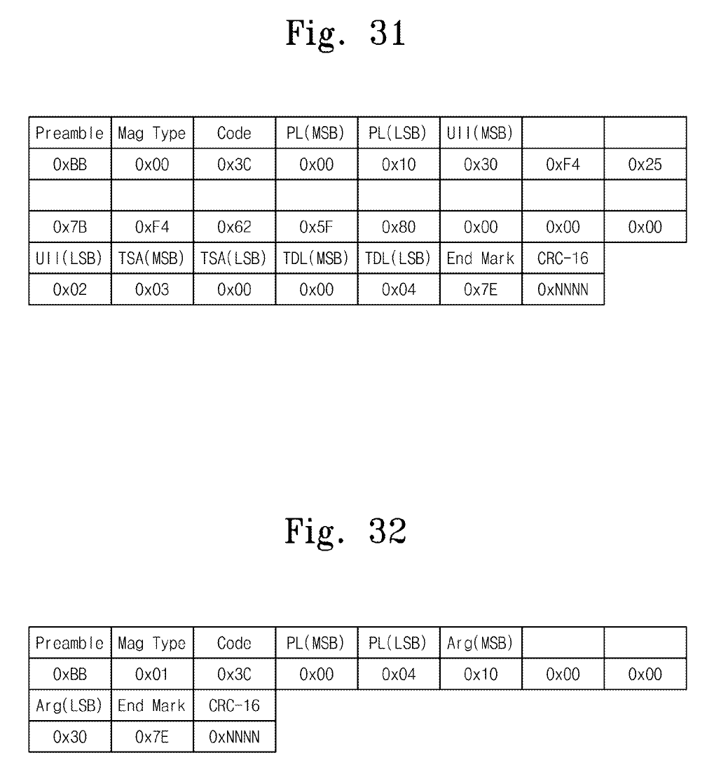

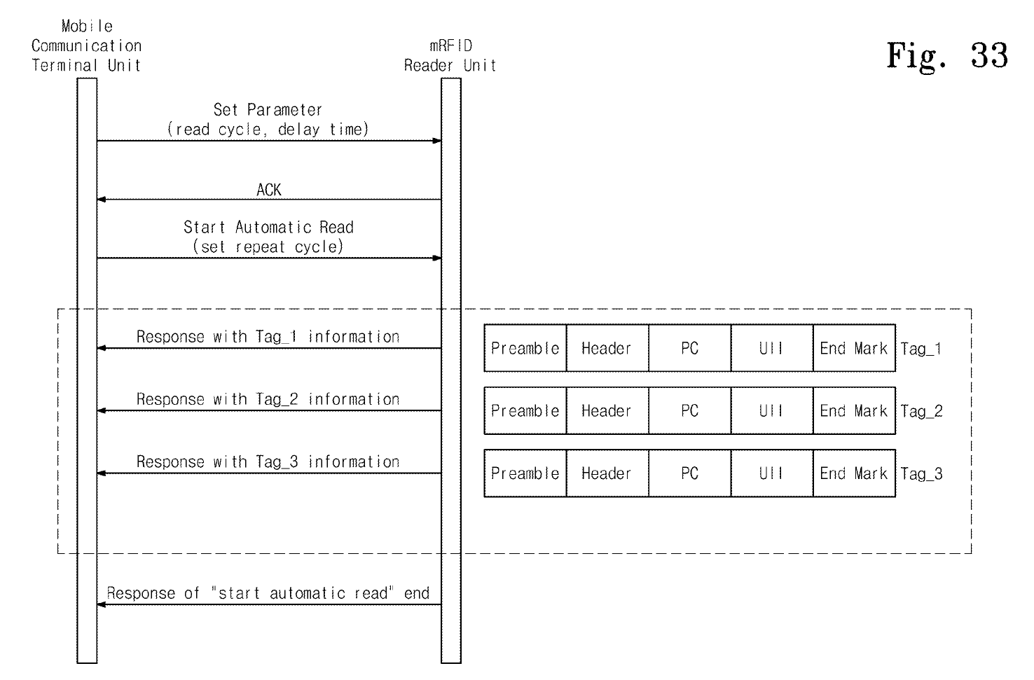

FIGS. 31 and 32 are diagrams illustrating an exemplary read type C TID command and response. Referring to FIGS. 31 and 32, the read type C TID command and response may include a CRC field following an end mark field.

FIG. 31 shows an exemplary protocol message structure for the read type C TID command. The read type C TID command may be used to read a TID memory bank region of an ISO/IEC 18000-6 type C tag. The TID memory bank region may be read from a start address through its length. When a protocol message is written for the read type C TID command, UII set may be required to indicate a tag to read a UII or TID memory bank. UII or UII set may have a variable length. On the other hand, other arguments may have fixed lengths. Therefore, the payload length may be obtained by adding four to UII or UII set.

The read type C TID command may include a message type, a code, a payload length, and an argument. The message type may be expressed as 0x00 indicative of command. The code may be expressed as 0x3C indicative of read type C TID. The payload type may be expressed by the payload type J (see FIG. 4, not shown). The payload type J may be configured with a first argument Arg1 having a variable size, a 16-bit second argument Arg2, and a 16-bit third argument Arg3.

Referring to FIG. 31, the argument may include a 96-bit UII or UII set, a 16-bit start address TSA of a TID memory bank region, and a 16-bit length TDL (TID Data Length, byte unit). In FIG. 31, UII may be 0x30F4257BF4625F8000000002, TID start address may be 0x0300, and the length may be 4-byte.

FIG. 32 shows an exemplary response protocol message structure for the read type C TID command. The response to the read type C TID command may include a message type, a code, a payload length, and an argument.

The message type may be expressed as 0x01 indicative of response. The code may be expressed as 0x3C in case of success, and may be expressed as 0xFF in case of failure. The payload type may be expressed by the payload type G (see FIG. 4, not shown) in case of success, and may be expressed by the payload type A (see FIG. 4) when a failure or a tag is not detected, or there is no TID data. The payload type G may be configured with a 32-bit argument.

The argument may include the content of the TID memory bank in case of success, may include 0x15 when a tag is not detected, may include 0x26 in case of read failure, and may include 0x1C when there is no TID data. In FIG. 32, the content of the TID memory bank may be 0x10000030.

III. Application of Command and Response

FIG. 33 is a flowchart illustrating an exemplary data communication method between the mobile communication terminal unit (111 of FIG. 1) and the mRFID reader unit (112 of FIG. 1). FIG. 33 shows an example of a start automatic read command. Referring to FIG. 33, a response provided from the mRFID reader unit 112 to the mobile communication terminal unit 111 may not include a CRC field.

According to the method described in FIG. 33, even when there is no more tag to be read, operation may stop after being performed as many as a predetermined number until a user stop the operation forcibly. Only one response is possible with respect to one tag. Accordingly, since a processor in an RFID device is too much loaded in recognizing many tags, malfunction may be caused. Also, much time may be taken due to much repetition of data.

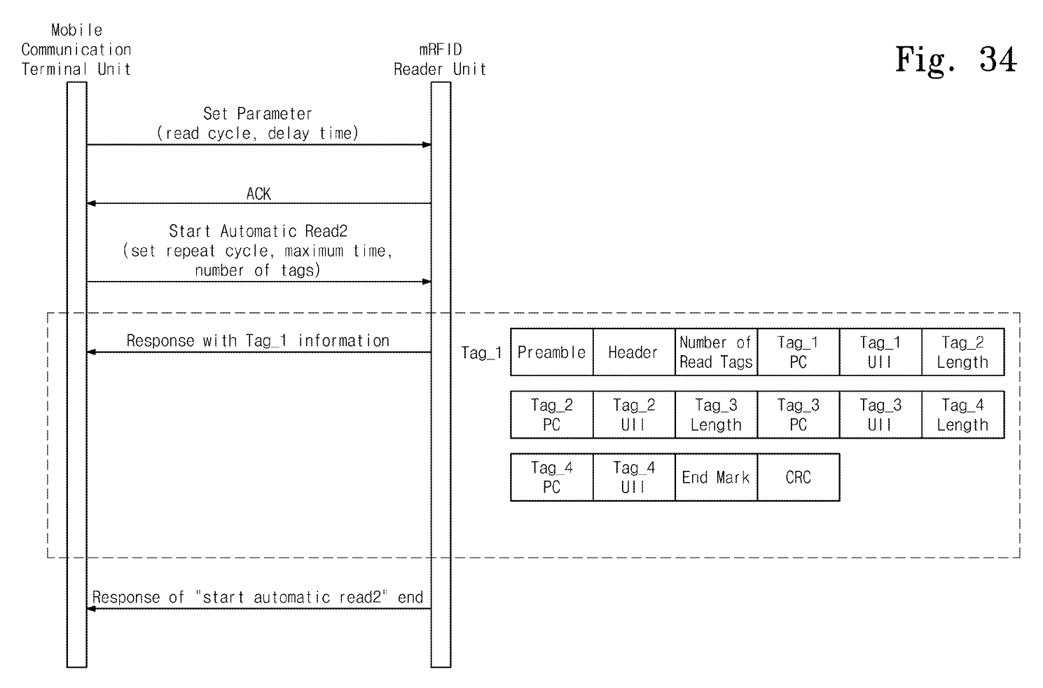

FIG. 34 is a flowchart illustrating another exemplary data communication method between the mobile communication terminal unit (111 of FIG. 1) and the mRFID reader unit (112 of FIG. 1). FIG. 33 shows an example of a start automatic read2 command.

Referring to FIG. 34, a response provided from the mRFID reader unit 112 to the mobile communication terminal unit 111 may include a CRC field. According to the method described in FIG. 34, since a CRC field is included in the end of a protocol message, it is possible to determine whether there is an error in a corresponding message. Accordingly, it is possible to prevent a serious error such as registering tag information received from the mRFID reader unit 112 as a response in a server.

Referring to FIG. 34, before sending an automatic tag read command to the mRFID reader unit 112, the mobile communication terminal unit 111 may set parameters such as a read cycle (1 read cycle equals to 1 inventory round) and a delay time (delay time between read cycles). Then, an ACK response may be sent from the mRFID reader unit 112 to the mobile communication terminal unit 111.

A start automatic read2 command including a repeat cycle (iteration number of read cycles), a tag read maximum duration, and a tag read maximum number may be provided from the mobile communication terminal unit 111 to the mRFID reader unit 112. The mRFID reader unit 112 may stop reading of tag if any one of predetermined conditions (e.g., whether a inventory round is performed as many as the read cycle or repeat cycle, tag read is performed for a predetermined maximum time, and tags are recognized as many as predetermined maximum tag number) is satisfied, there is no more tag to be read, or a user stops operation forcibly.

The mRFID reader unit 112 may put all tags read at a predetermined interval (e.g., about 1 second) during tag read in one message and may deliver the message to the mobile communication terminal unit 111. When the start automatic read2 operation is stopped, a completion response may be sent to the mobile communication terminal unit 111. This concerns improvement of an inefficient method in which the mRFID reader unit 112 executes an inventory round unconditionally by a predetermined iteration number.

According to the method described in FIG. 34, when the number of tags recognizable by the mRFID reader unit 112 is small, it is possible to reduce repetition of tag recognition operation of the mobile communication terminal unit 111 and the mRFID reader unit 111 and minimize tag recognition time. For example, when the maximum number of readable tags is three, the maximum tag count is set three in the mobile communication terminal unit 111. When three tags are recognized, a start automatic read2 operation may be allowed to be automatically completed.

The mobile RFID device according to an embodiment may include a CRC field in a command or response, thereby checking an error of the command or response transmitted and received between a mobile communication terminal unit and an mRFID reader unit. According to an embodiment, malfunction of the mobile RFID device 100 due to the error of the command or response can be prevented.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A data communication method of a mobile Radio Frequency Identification (RFID) device, comprising:
providing, by a mobile communication terminal unit, a command to an mRFID reader unit and receiving a response to the command from the mRFID reader unit; and
checking whether there is an error in a protocol message of the command or the response, and re-transmitting the command to the mRFID reader unit according to a check result.

2. The method of claim 1, wherein the command and the response comprise a Cyclic Redundancy Check (CRC) field to check the error of the protocol message, respectively.

3. The method of claim 2, wherein the CRC field follows an end mark field of the protocol message.

4. The method of claim 1, wherein the re-transmission number of the command is limited to K (K is a natural number).

5. A mobile Radio Frequency Identification (RFID) device comprising:
a mobile communication terminal unit providing a command; and
an mRFID reader unit providing a response to the command to the mobile communication terminal unit,
wherein the communication terminal unit and the mRFID reader unit comprise a Cyclic Redundancy Check (CRC) circuit to check whether there is an error in a protocol message of the command or the response, respectively, and
the communication terminal unit re-transmits the command to the mRFID reader unit according to a result of the error check.

6. The mobile RFID device of claim 5, wherein the command and the response comprise a CRC field to check the error of the protocol message, respectively.

7. The mobile RFID device of claim 6, wherein the command is a set security key command, and the set security key command comprises information on an Electronic Serial Number (ESN), a phone number, and a user assignment key.

8. The mobile RFID device of claim 6, wherein the command is a set frequency mode command, and the set frequency mode command comprises information on a frequency hopping mode, a Listen before Talk (LbT) mode, or a specific frequency use.

9. The mobile RFID device of claim 6, wherein the command is a set Medium Access Control (MAC) control command, and the set MAC control command comprises information on whether a MAC is used.

10. The mobile RFID device of claim 6, wherein the command is a start automatic read command, and the start automatic read command comprises information on a maximum number of tags, a tagging maximum duration, and a repeat cycle.
